(19) United States
(12) Patent Application Publication
(10) Pub. No.: US 2014/0126740 A1
(43) Pub. Date: May 8, 2014

(54) Wireless Earpiece Device and Recording System

(71) Applicants: Joel Charles, Elmont, NY (US); Adrian Ali, Woodhaven, NY (US)

(72) Inventors: Joel Charles, Elmont, NY (US); Adrian Ali, Woodhaven, NY (US)

(21) Appl. No.: 14/071,919

(22) Filed: Nov. 5, 2013

Related U.S. Application Data
(60) Provisional application No. 61/722,280, filed on Nov. 5, 2012.

(51) Int. Cl. H04R 1/10

(52) U.S. Cl. CPC H04R 1/1041
USPC 381/74

(57) ABSTRACT

An audio recording device and associated recording system are provided for recording and compiling individual audio tracks from a group performance. Each audio recording device is a wireless earpiece having a generally c-shaped body. At one end of the device is an ear bud speaker, retractably anchored within the earpiece body. At an opposing end of the earpiece body is a power transfer port. When sound recording is activated, a microphone in the earpiece captures audio and transmits same via a data communication signal. The signal is received by a client computing device or by the master editing computer. Multiple users wearing the audio recording device can transfer recordings to the master editing computer at the same time. These tracks can then be edited and compiled into a signal track.

### CROSS REFERENCE TO RELATED APPLICATION

This application claims the benefit of U.S. Provisional Application No. 61/722,280 filed on Nov. 5, 2012, entitled “Ear Pro.” The patent application identified above is incorporated here by reference in its entirety to provide continuity of disclosure.

### BACKGROUND OF THE INVENTION

1. Field of the Invention

The present invention relates to a wireless recording device. More specifically, it relates to a wireless ear piece in communication with an audio manipulation system. The ear piece fits around the outside of a user's ear and has a retractable speaker that rests on the outside of the user's ear canal. The ear piece plays audio via the speaker and records audio via a built-in microphone. Recorded audio is transmitted to a nearby computer running audio manipulation software. The device and system will be appreciated by audio recording artists who want to record band sessions.

Audio production studios employ a variety of microphones, electrically wired to audio manipulation equipment. Because there may be several instruments or singers performing during a studio session, a number of microphone varieties are used in each session. Omni-directional microphones pick up ambient sound from the surrounding area and are ideal for recording composite sounds and background noise. Uni-directional and bi-directional microphones are best suited for recording audio input from a single source such as singers in a band, or the primary vocalists in a chorus.

The problem with conventional audio recording studio microphones is that they are often bulky and require one or more wire connections. It is difficult for performers to hold a microphone while singing or playing an instrument. Microphone stands, boom rigging and other structures are used to hold a microphone in a stable position. These structures alleviate the need for holding a microphone during a performance, but they present a risk of injury. Wires extending from the microphones can entangle the feet of users and the microphone stand or support itself can be tripped over during a performance.

A new audio recording device is needed that is wireless and can record composite environmental sound or single audio input. The wireless ear piece device should be adapted for wireless communication with a computer system. The computer system is running a software program that receives the audio input and allows a user to manipulate the recorded audio, separating it into individual tracks and adding effects as desired.

2. Description of the Prior Art

The present invention is a device and system for audio recording and manipulation. It includes a c-shaped ear piece having a retractable audio speaker that is held in a stowed position by magnets. The ear piece can record composite audio or filter out environmental noise using noise cancellation. Recorded audio is transmitted to a computer system via Bluetooth or other short range wireless protocol. A software program running on the computer system features a number of audio manipulation functions. In this manner, the device and system facilitate wireless audio recording and music production. The following prior art devices are considered to be a list of devices pertinent to the present disclosure.

Wireless ear pieces are known in the art and are frequently used to facilitate hands-free use of cell phones and similar devices. These devices are commonly referred to as “Bluetooth headsets.” Examples of such headsets are disclosed in Belisle, U.S. Patent Application Publication No. 2012/0,330,645 and Kroll, U.S. Pat. No. 8,340,731. These devices offer voice recording and audio playback, but generally feature noise cancellation features that cannot be turned off, making it extremely difficult to record composite sound from the surrounding environment.

Ryann, U.S. Patent Application Publication No. 2007/0,049,351 teaches a wireless ear piece that includes a clothing clip. The ear piece has a c-shape that wraps around the outer part of a user's ear. An ear canal speaker extends from an upper end of the ear piece and is attached to a wire running through the c-shape. The opposing end of the wire is attached to a flexible clip that removably secures to the user's clothing. A microphone is integrated into the ear piece assembly for recording a user's speech. The device is useful for hands-free communication with a wireless device. Ryann does not disclose the use of audio manipulation software or the ability to record composite sound.

Singhal, U.S. Patent Application Publication No. 2013/0,066,636 teaches a headset that records ambient noise from a user's surrounding environment. The headset is a u-shaped collar device having a right and left ear piece. Directional speakers using high frequency ultra sound emitters are used to ensure that only the user can hear the audio output from the speakers. This allows the user to listen to audio playback without disturbing people around him. Wireless communication devices such as smart phones, tablet computers and the like. A microphone installed near the ear pieces picks up the user's voice and can also be used to collect ambient noise. The Singhal device is thus a hands free and heads free speaker system that doesn't attach to the user's ears and therefore doesn't obstruct hearing. Singhal does not disclose a single ear piece having a retractable speaker.

Goldstein, U.S. Patent Application Publication No. 20120288104 teaches a device and method for audio recording. The device is a headset having two ear pieces. One ear piece includes a microphone for picking up ambient noise in the surrounding environment, and the other ear piece includes a microphone for picking up internal ear canal noise such as speech. A method is included for combining the two recorded audio streams. Recorded audio is buffered and can be played back upon the occurrence of an event such as a voicemail, a voice command, a depressing of a button, or the like. Goldstein does not disclose a single ear piece having a retractable speaker that fits within the ear canal, Goldstein also does not teach a separate computer running an audio manipulation software program that is in communication with the ear piece.

These prior art devices have several known drawbacks. The do not disclose a wireless ear piece that can record audio from a single source or from a group source. Nor do they disclose a wireless ear piece that is part of an audio production system. The present invention addresses these shortcomings with a wireless ear piece that can record multiple audio input types and transmit it to a computer running audio production software. It substantially diverges in design elements from the prior art and consequently it is clear that there is a need in the art for an improvement to existing devices and systems. In this regard the instant invention substantially fulfills these needs.

### SUMMARY OF THE INVENTION

In view of the foregoing disadvantages inherent in the known types of wireless audio recording ear pieces now present in the prior art, the present invention provides a new retractable speaker and audio production system wherein the same can be utilized for providing convenience for the user when recording performance sessions without impeding the range of motion of the performers.

The present invention is a wireless earpiece device in communication with one or more computing devices. Working in conjunction, the system and device facilitate audio recording of one or more performers and editing of recorded tracks. Performers can record their sessions without the need for expensive equipment

The ear piece is a wireless audio recording and playback device. It has a c-shaped, flexible body that fits around the user's outer ear, between the ear and the head. At one end is a magnetic cup with a central aperture from which a retractable cord extends. A speaker ear bud is attached to the end of the cord. The ear bud has a magnetic back piece. When the ear bud is retracted, the magnetic connection between the body and the ear bud holds the ear bud in a stowed position. At the opposing end of the ear piece body is a power transfer connection port that accepts a jack to a power cord such as a d/c connection or a universal serial bus connection.

The earpiece wirelessly exchanges data with an individual wireless computing device or a separate computer system. Multiple users can join together to create a unique recording session that can be edited real time or stored for later use. Each user can pair the device with their smart phone, tablet computer, or other wireless computing device. An application installed on the device facilitates recording initiation, volume adjustments, and noise cancellation. Though each user controls basic settings on her wireless computing device, real time audio editing functions are available to the “group leader” as designated within the application prior to the beginning of recording. The audio recording session is saved on the separate computer system, which may be a local computer or a remote server.

It is therefore an object of the present invention to provide a new and improved wireless audio recording and playback ear piece that has all of the advantages of the prior art and none of the disadvantages.

It is therefore an object of the present invention to provide an easy to use and cost effective means of recording individual or group performance sessions.

Another object of the present invention is to provide a flexible, lightweight ear piece that is universally sizeable.

Yet another object of the present invention is to provide an ear piece that has a freely positionable ear bud on a retractable cord, and to further provide a stable stowed position for the ear bud to reduce the likelihood of damage when not in use.

Still another object of the present invention is to provide an audio recording system that utilizes wireless microphones and allows each performer to control the basic settings of his recording.

A further object of the present invention is to provide a system for audio recording that employs an audio recording device capable of both noise single source recording and composite recording.

A still further object of the present invention is to provide a system of wireless communications devices and a computer running audio production software, which controls the audio recording sessions of individual users.

A yet further object of the present invention is to provide a system for audio recording wherein individual tracks are recorded via one or more ear pieces and are ultimately transferred to a computer system for master editing and storage.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a side view of the ear piece of the present invention. The ear bud is in the stowed position.

FIG. 1B shows a side view of the ear piece device of the present invention. The ear bud and cord are shown extending away from the ear piece body in a ready-for use state.

FIG. 2 shows a perspective view of the ear piece device in use as worn around an individual's ear.

FIG. 3 shows a bottom view of the ear piece device with the power transfer port visible.

FIG. 4 shows a perspective view of the coupling between the ear piece body receiving cup and the retractable ear bud.

FIG. 5 shows a schematic diagram of the internal components of the wireless ear piece device

FIG. 6 shows a general system diagram of an exemplary embodiment of the audio recording system.

FIG. 7 shows an exemplary screen shot of the software application of the present invention.

### DETAILED DESCRIPTION OF THE INVENTION

Reference is made herein to the attached drawings. Like reference numerals are used throughout the drawings to depict like or similar elements of the wireless audio recording device and system. For the purposes of presenting a brief and clear description of the present invention, the preferred embodiment will be discussed as used for recording and editing audio performances. The figures are intended for representative purposes only and should not be considered to be limiting in any respect.

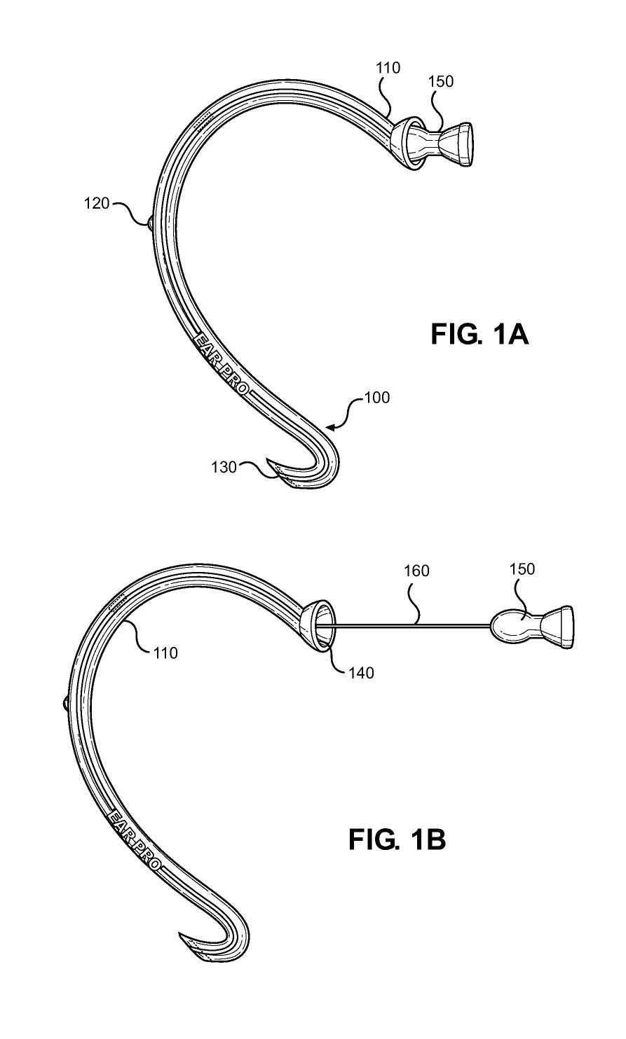

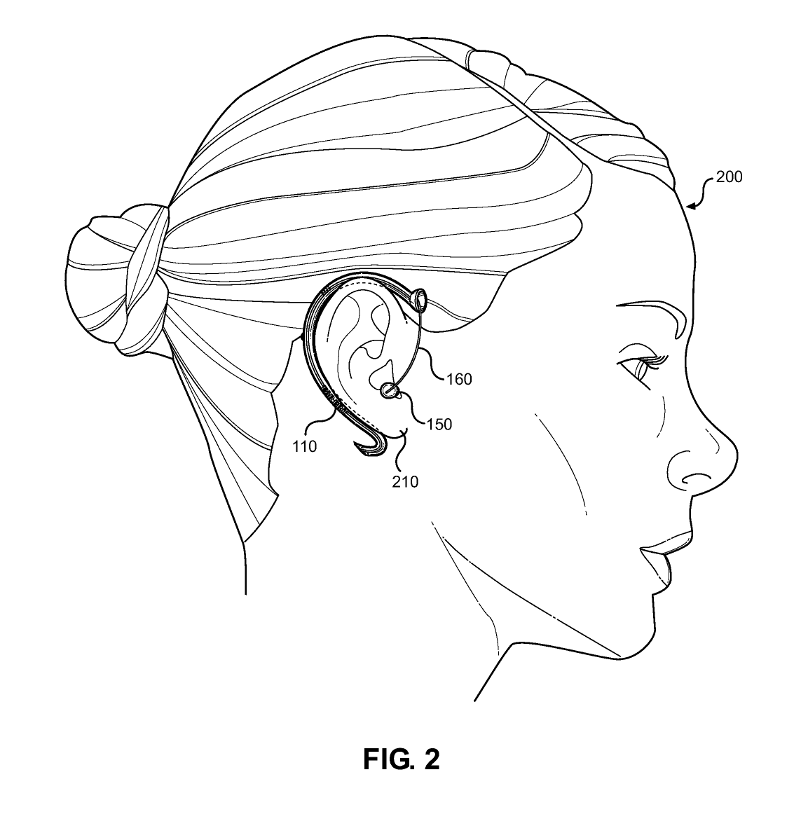

Referring now to FIGS. 1A and 1B, there is shown a wireless audio recording ear piece according to the current invention. The ear piece device 100 has a generally c-shaped body 110 with an upturned tail 130 at the lower end and a cup shaped recess 140 at the upper end. A retractable speaker ear bud 150 rests within the cup shaped recess while in the stowed state shown in FIG. 1A, and extends away from the body, connected by a wire 160, when in a deployed state, as in FIG. 1B. A microphone is disposed anywhere along the general body length of the device and is exposed via a small aperture in the device surface. The back ridge of the c-shaped body has a power switch 230 disposed thereon. It may be a sliding switch, a rocker switch, a depressible button, or any other suitable activation means.

Ease of use is a primary focus of the present invention, thus the ear piece is intended for easy insertion and removal. The body is constructed of a lightweight memory alloy such as copper-aluminum-nickel or nickel titanium. A soft rubber coating covers the metal memory alloy frame. This construction facilitates the device holding its shape after manipulated by a user. Users can easily form the device to fit their ears and will not need to constantly re-configure the device at each deployment.

An additional convenience enhancing function is the inclusion of illumination stripes running the length of the device. A portion of the rubber coating may be somewhat translucent to permit light from one or more light emitting diodes (LEDs) to pass through the coating. These lights will illuminate whenever the device is activated to let persons in the surrounding area know that the wearer is using a wireless recording device. In a preferred embodiment the device will illuminate with a different color of LED or illumination pattern when audio recording is in progress. By way of example, when the user selects a “record” button on the wireless computing device paired with the ear piece device illumination changes from the color blue to red, or begins to blink rather than having a steady glow. The illumination stripes may be created by embedding individual LED elements within the body of the device and covering them with a translucent strip. Alternatively, translucent tubing having electrically connected ELD elements may be inset into the body of the audio recording device and connected to the onboard battery.

Referring now to FIG. 2, there is shown a user wearing the wireless ear piece device. A woman 200 is shown in a side profile with the wireless ear piece device 100 worn on her ear 210. The c-shaped body 110 is contoured to conform to the shape of the joint of a user's ear. As shown, the body of the device rests on the joint of the user's ear, between the ear itself and the user's head. The cup shaped recess rests near the upper forward portion of the ear, providing the retractable speaker connection wire unobstructed access to the ear canal. Because the device body rests on the sensitive skin tissue on the back and joint of a user's ear it is important that the rubber coating or casing is soft and nonabrasive. It is preferred that the coating or casing has a matte finish rather than a polished or smooth finish to reduce slippage during wear.

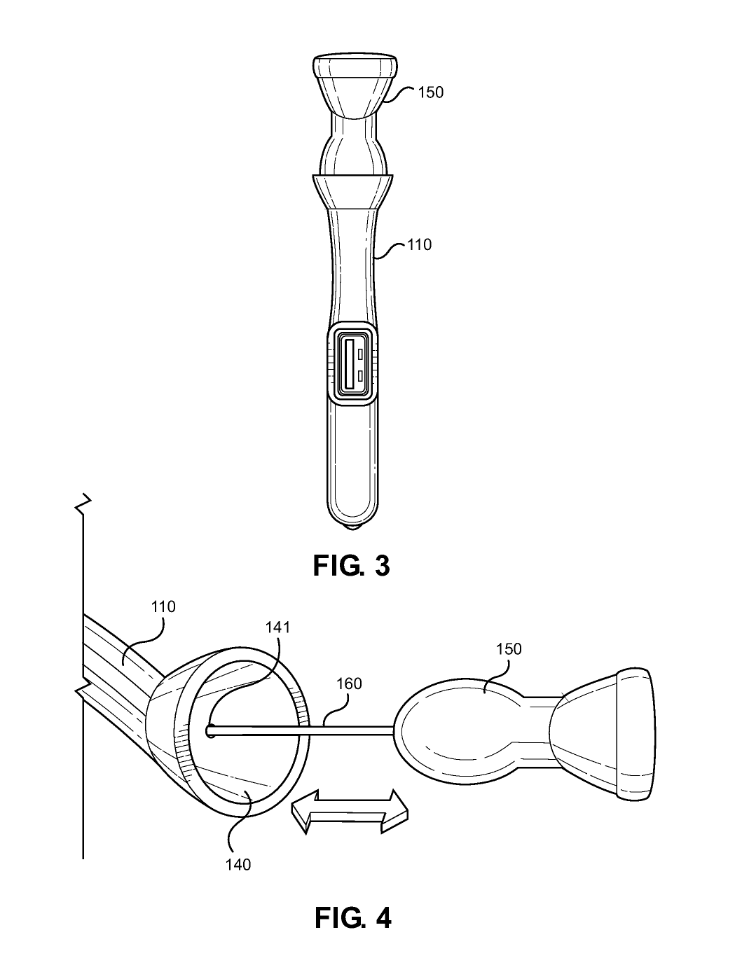

Another view of the ear piece device is shown in FIG. 3. The underside of the wireless ear piece device 100 is shown, revealing the power transfer port 170 disposed along the upturned tail 130. A portion of the upper body underside is viewable, along with the speaker ear bud 150. A variety of power transfer types may be used according to the power needs of the intended user. Shown in the figure is a universal serial bus port (USB) which can be used to connect the device to a wall outlet, handheld wireless computing device or desktop personal computer. This type of connection also features data transfer capabilities, which could be employed while audio recording is in progress. Alternatively a standard DC power connection can be used as the power transfer port. A standard wall plug is plugged into the connection port to charge the device's onboard battery. In either embodiment, the port should be located on the bottom of, or outside edge of the upturned tail. The tail's outwardly curved shape makes it easy to plug a power connection into the device while it is in position on a user's ear. Placing the port near the top of the device or along an interior edge would result in unbalancing of the deployed device.

Referring now to FIG. 4, there is shown a close up view of the coupling between the upper end of the earpiece device and the retractable speaker ear bud. The upper portion of the earpiece body 110 terminates in a cup shaped recess 140. An aperture 141 in the cup shaped recess provides access to the body interior. Extending from within the body interior, through the aperture is a connection wire 160 that is secured to the back end of the speaker ear bud 150. The wire is anchored within the ear piece body interior to prevent the ear piece from detaching entirely. Tension based spooling of the wire may occur within the ear piece. For example, a small spool disposed against or near the back wall of the cup shaped recess may pull the wire into the body interior after a user tugs gently on the speaker ear bud. A second tug will lock the spool in place allowing positioning of the speaker within the ear canal. In alternative embodiments, there is no spool within the body interior, only a cavity in which the connection wire is stored.

To keep the speaker in place when it is not in use, the cup shaped recess and the back of the speaker ear bud are coated in, or formed from a ferrous substance. The back of the speaker ear bud is convex in shape and should mate with the cup shaped recess. When the speaker ear bud is pulled back into the cup shaped recess, a magnetic connection between the two surfaces is formed, thereby helping to keep the speaker within the recess.

A variety of ear bud embodiments may be employed. Speaker ear buds are electrically connected to the wireless ear piece processing unit via the connection wire and are used to emit audio into the wearer's ear canal. Ear buds of this type are available in many shapes and sizes. The specific design of the ear bud may vary to meet the preferences of different consumers. So long as the back portion of the speaker ear bud is made from or coated in a ferrous material, any ear bud type may be used.

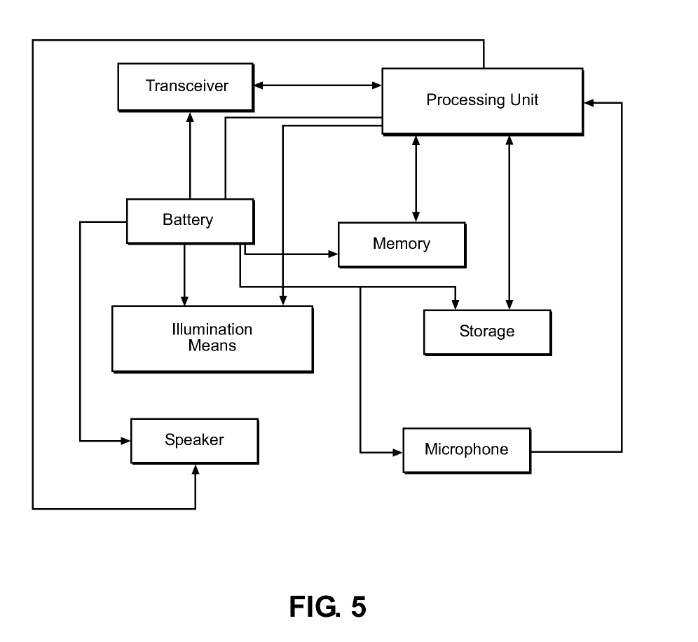

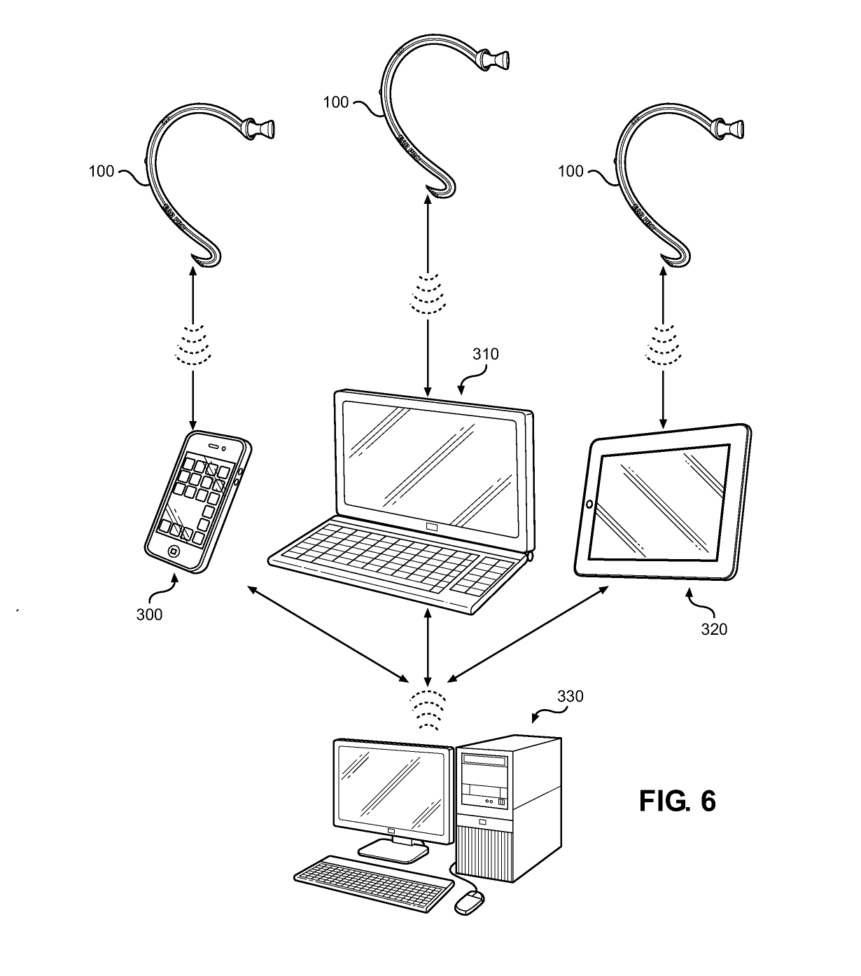

Turning to FIG. 5 there is shown a schematic diagram of the wireless ear piece device. The device has a processing unit 200 in the form of a processor chip with a plurality of input and output terminals. A memory 210 such as read only memory and a storage unit 220 are operatively connected to the processing unit such that data is loaded into and out of memory and the storage unit from the processing unit. The microphone 240 is connected to an input terminal of the processor chip while the speaker 230 is connected to an output terminal. In this way sound is recorded via the microphone and sent to the processing unit where is converted to a digital data and loaded into memory for transmission. Large amounts of recording may require the use of the storage unit to buffer the data prior to transmission. The recorded audio may also be played back via the speakers to permit users to hear the sound of their voice during recording. A transceiver 250 is operatively connected to the processing unit and includes a radio antenna for transmitting and receiving data signals over radio frequency bands. In a preferred embodiment the device utilizes Bluetooth technology to transfer data between the earpiece device and a wireless computing device or other computer.

In addition to the aforementioned component connections, the ear piece device also contains an illumination means and a battery. The illumination means 260 is one or more light emitting diodes (LEDs) arranged along the length of the body interior. Each light may be the same color or alternatively may be different colors to facilitate easy visual recognition of whether or not recording is in progress. Like all the device components, a rechargeable battery powers the illumination means.

An overall depiction of an exemplary implementation of the present system is shown in FIG. 6. One or more of the above described wireless earpiece devices are in communication with, or paired to, one of a variety of client wireless communication devices such as laptop computers 310, smart phones 300, and tablet computers 320. Each of these client devices runs a client software package that enables and facilitates user control of paired earpiece devices. The multiple communication devices are in operable communication with a server or personal computer running a master audio editing software package. Alternatively, the wireless earpieces may communicate directly with the personal computer or server 330. It should be understood that these devices might also transfer data via wired connections such as USB. In an alternative embodiment the connection between the wireless computing devices and the personal computer/server may be a remote connection over a network such as the Internet.

During use, audio is recorded via the microphone of the earpiece and transferred to the respective client wireless communication device. Upon user interaction with the client software package, control signals are sent from the client communication devices to their respective wireless earpieces. In this manner, the user initiates audio recording, adjusts recording and playback volume, activates and deactivating noise cancellation and applies minor audio effects. Control signals are received by the transceiver within the earpiece device and sent to the processing unit, which adjusts input and output settings as necessary. Audio performance recordings are transmitted from the earpiece device or an associated client communication device to the personal computer or server where they can be edited or transferred to removable storage media formats.

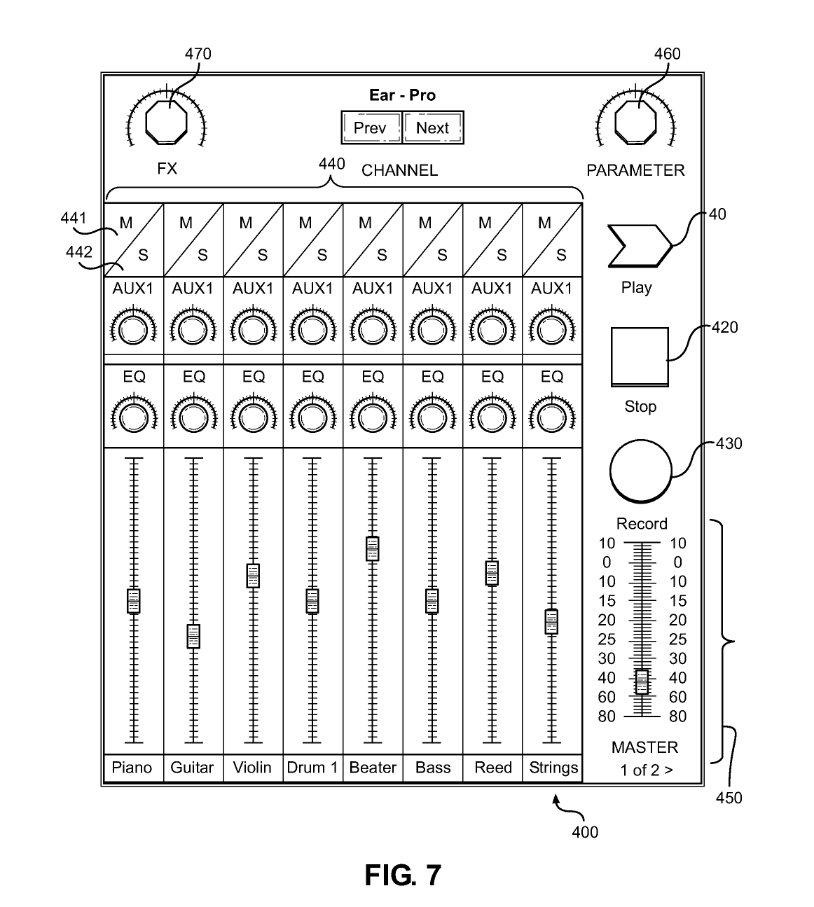

Each of the client devices and the personal computer/server has an installed client software application that facilitates audio recording and editing. An exemplary implementation of editing software is shown in FIG. 7. Once a wireless earpiece device is paired with or connected to a wireless communication device, the software application initiates data transfer to and from the earpiece device. A recording activation button within the software application user interface provides a visual representation of the audio recording activation command 430. Recording is stopped 420 and played back 440 via other user interface indicia. Similarly volume controls 450 are presented to the user to facilitate precise control over recorded sound levels. Similarly, noise cancellation software installed on the earpiece may be activated and deactivated using the client software program. When noise cancellation is activated, noise associated with the surrounding environment is filtered out, and only the user's voice is recorded. Activating noise cancellation within each earpiece enables the recording of a plurality of individual tracks for any given group performance. These group tracks can then be edited and combined using the master editing software, thereby creating one audio performance recording from several individual tracks.

In the master editing software package, individual recordings received from different earpieces or client communication devices may be edited. Individual channel settings 440 including mono 441 and stereo 442 sound toggling may be used on each recording. The editor may switch between recorded tracks using on-screen indicia and may adjust various effects and parameters 470, 480 for each track.

The present invention is a wireless audio recording device in the form of an earpiece and an associated audio editing system. It enables multiple users to record audio during a recording session. These tracks can then be transmitted to a master computing device, where they are edited and combined to create a single audio track. In this way, the invention provides performing groups with a simple way to record and produce audio tracks without requiring expensive and cumbersome equipment. Using the noise cancellation functionality of the earpiece devices, recording can take place in almost any environment, eliminating the need for users to access an actual recording studio. Thus, the invention is a portable device and easy to use system for recording audio performances that is inexpensive to implement.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An audio recording device, comprising:
an earpiece body having a first end, a second end, and an interior;
a speaker, wherein said speaker is detached from said earpiece body;
a retractable wire secured at one end to said speaker, and anchored to and extending from said interior of said earpiece body;
a microphone;
a battery;
a transceiver;
a memory;
a storage;
a processing unit operably connected to said speaker, said microphone, said transceiver, said memory, and said storage;
a power transfer port;
a power switch.

2) The audio-recording device of claim 1, wherein said earpiece body is c-shaped with said first end is an upper terminus of said earpiece body and said second end is a lower terminus of said earpiece body.

3) The audio-recording device of claim 1, wherein said retractable wire is tension spooled within said earpiece body interior.

4) The audio-recording device of claim 1, wherein said power transfer port is also a data transfer port.

5) The audio-recording device of claim 1, wherein said second end of said earpiece body is an up-turned tail.

6) The audio-recording device of claim 1, further comprising:
one or more illumination stripes extending along a portion of the length of said earpiece body.

7) The audio-recording device of claim 6, wherein said illumination stripes illuminate according to the current usage state of said audio-recording device.

8) The audio-recording device of claim 1, wherein said speaker is an ear bud speaker.

9) The audio-recording device of claim 1, wherein said power transfer port is located near said second end.

10) The audio-recording device of claim 1, further comprising:
noise cancellation software capable of reducing background environmental noise during recording, wherein said noise cancellation software may be enabled or disabled by a user.

11) The audio-recording device of claim 1, wherein said first end of said earpiece body is a concave recess adapted to receive a back portion of said speaker.

12) The audio-recording device of claim 11, wherein said concave recess and said back portion of said speaker are constructed of or coated with a ferrous material such that said back portion and said concave recess are magnetically attractive.

13) An audio-recording system, comprising:
one or more audio-recording devices as in claim 1;
one or more client communication devices designed to transfer data to and from said one or more audio-recording devices;
one or more master computing devices designed to transfer data to and from said one or more client communication devices;
a network;

14) The system of claim 13, wherein each of said client communication devices has a client software package capable of controlling operation of said one or more audio-recording devices.

15) The system of claim 13, wherein each of said one or more master computing devices has a master editing software package capable of manipulating audio recorded by each of said one or more audio-recording devices.

16) An audio-recording system, comprising:
one or more audio-recording devices as in claim 1;
one or more master computing devices designed to transfer data to and from said one or more audio-recording devices.

17) The system of claim 16, wherein each of said master computing devices has a software package capable of controlling operation of said one or more audio-recording devices.

18) The system of claim 16, wherein each of said one or more master computing devices has a software package capable of manipulating audio recorded by said one or more audio-recording devices.
